(19) United States
(12) Patent Application Publication
(10) Pub. No.: US 2009/0214913 A1
(43) Pub. Date: Aug. 27, 2009

(54) Temperature regulating system for fuel cells and method for regulating the temperature of fuel cells

(76) Inventor: Thomas Gschwind, Bad Durkheim (DE)

Correspondence Address: PAUL A. FATTIBENE;FATTIBENE & FATTIBENE, 2480 POST ROAD, SOUTHPORT, CT, 06890, US

(21) Appl. No.: 12/380,200

(22) Filed: Feb. 25, 2009

(30) Foreign Application Priority Data
Feb. 26, 2008 (DE) 102008011235.6

(51) Int. Cl. H01M 8/04

(52) U.S. Cl. 429/24; 429/26

(57) ABSTRACT

The present invention relates to a temperature regulating system for fuel cells (14) and to a method for regulating the operative temperature of a fuel cell (14). To bring the operating temperature of the fuel cell (14) as fast as possible to a value within a set temperature range and to be able to keep the value within the range, it is provided according to the invention that the temperature regulating system comprises at least one electric heating device (2) which together with at least one cooling element (3) forms a temperature-controlling stack (7, 8).

### FIELD OF THE INVENTION

The present invention relates to a temperature regulating system for fuel cells, comprising at least one electric heating device and at least one cooling element, the heating device and the cooling element being connected via a heat bridge to at least one temperature-controlling channel passing through the temperature regulating system, the temperature-controlling channel being connectable in fluid-conducting fashion to a heat transport line which is formed at least between the temperature regulating system and the fuel cell by a temperature-controlling circuit conducting a temperature-controlling fluid.

Furthermore, the present invention relates to a method for regulating an operating temperature of a fuel cell, wherein a heat flow is conducted from a heating device via a heat transport line to the fuel cell, and the heating device is fed from a source of electrical energy or an energy storage device when the operating temperature is below a first set temperature, and wherein, when a second set temperature is exceeded, the heat flow is conducted from the fuel cell via the heat transport line to a cooling element.

### BACKGROUND OF THE INVENTION

Temperature regulating systems for cooling energy converters for automotive vehicles, such as combustion engines, are known in general. From the cooling system a coolant, e.g. water, which has been cooled in said system, is supplied through a closed coolant circuit to the energy converter which discharges heat to the coolant.

Fuel cells have the advantage that they convert energy with smaller heat losses and also at lower operating temperatures than combustion engines. Here, however, the problem arises that the temperature regulating systems that have so far been used do not adequately influence the operating temperature of the fuel cell. A fuel cell, particularly if used in an automotive vehicle, heats up due to the small heat losses at a slower rate than the combustion engine, whereby the operating temperature of the fuel cell reaches a set temperature range only after a relatively long period of time. In addition, it is difficult with the existing cooling systems to keep the operating temperature within this set temperature range.

Cooling systems for fuel cells or for other components of fuel cell systems are described in publications DE 10 2006 005 176 A1, DE 11 2006 001 348 T5, DE 11 2005 000 360 T5, DE 11 2004 002 618 T5, DE 102 35 464 A1, DE 101 07 596 B4, and DE 199 31 061 A1. These use a complex line system for transporting the temperature-controlling fluid to the heating device and to the cooling element. Depending on the application, the temperature-controlling fluid is here at least partially guided past the heating device and the cooling element via additional bypass lines. Complex line systems require a lot of space. Space, however, is limited in modern cars.

### SUMMARY OF THE INVENTION

It is therefore the object of the present invention to provide a temperature regulating system for fuel cells and a method for regulating the operating temperature, which makes it possible to reach a first set temperature as fast as possible and ensures a regulation of the operating temperature of the fuel cell between the first and a second set temperature during operation of the fuel cell without the temperature regulating system requiring a lot of space.

As for the above-mentioned temperature regulating system, this object is achieved according to the invention in that the temperature-controlling channel, the cooling element and the heating device are joined to form a temperature-controlling stack. As for the above-mentioned method, this object is achieved according to the invention in that the heat flow is passed over at least one temperature regulating system according to the invention.

With these measures it is possible to heat the fuel cell at a faster rate up to the first set temperature than by way of its self-heating alone and to keep the operating temperature of the fuel cell within the set temperature range distinguished by the first and the second set temperature, with the temperature regulating system being given a compact design.

The solution according to the invention can be further improved by means of various embodiments that are each advantageous as such and can be combined with one another in any desired way. These embodiments and the advantages associated with them shall be addressed hereinafter.

For instance, heat can flow between the fuel cell and the temperature regulating system by means of a heat transport line. The heat transport line can be formed by a temperature-controlling circuit, which may encompass the temperature regulating system and the fuel cell. The fuel cell can exchange heat also via a heat exchanger with the temperature-controlling circuit.

In the temperature regulating system according to the invention at least one electric heating device and at least one cooling element are connected via a heat bridge to at least one temperature-controlling channel passing through the temperature regulating system, the temperature-controlling channel being connectable in fluid-conducting fashion to a heat transport line which is formed at least between the temperature regulating system and the fuel cell by a temperature-controlling circuit conducting a temperature-controlling fluid.

In the method according to the invention a heat flow is passed for regulating an operating temperature of a fuel cell from a heating device via a heat transport line to the fuel cell and the heating device is fed from a source of electrical energy or an energy storage device if the operating temperature is below a first set temperature and, when a second set temperature is exceeded, the heat flow is guided from the fuel cell via the heat transport line to a cooling element.

A temperature-controlling channel can be connected in heat conducting fashion as part of the temperature-controlling circuit to the heating device and the cooling element and can be enclosed by said members either individually or jointly at both sides. These components of the temperature-controlling system can be arranged in parallel with a longitudinal direction of the temperature-controlling channel and jointly form a temperature-controlling stack.

The temperature-controlling channel may e.g. consist of a heat-conducting metal, such as aluminum, with which heat from the heating device can be absorbed and delivered to the cooling element. It is particularly advantageous when a temperature-controlling fluid can flow through the temperature-controlling channel and the remaining part of the temperature-controlling circuit, which also encompasses the fuel cell, the temperature regulating system and at least one heat transport line. The heat transport lines pass heat between the fuel cell and the temperature-controlling module.

For instance water or alcohol or a liquid or gas mixture can be used as the temperature-controlling fluid, which can absorb and discharge the heat in the fuel cell and/or in the temperature regulating system and which is transported through the temperature-controlling module. For the transportation of the temperature-controlling fluid the channel and the heat transport lines may comprise an opening which extends in the longitudinal direction thereof and through which the heat transporting means can flow.

However, it is also possible to use substances as the temperature-controlling fluid that change their state of aggregation for heat transportation and particularly evaporate for heat absorption and condense for heat discharge.

For an improved discharge of heat to the coolant the cooling element may be configured such that the coolant can flow therethrough. At least one through-flow channel may here e.g. extend in parallel with the longitudinal direction of the temperature-controlling channel. To improve the efficiency of the heat transfer to the coolant, it may be advantageous when the through-flow channel extends in a direction transverse to the said longitudinal direction.

Heat distribution structures which may e.g. be ribbed or grid-shaped and made from a heat-conducting material, such as aluminum, can extend into the opening of the through-flow channel. In order not to unnecessarily increase the flow resistance of the coolant through the through-flow channel and to achieve a high heat output to the coolant, it is advantageous when the webs have a small cross-section in a direction transverse to the flow direction of the heat absorbing medium and a large surface in the direction of flow. Especially cooling ribs or cooling lamellae arranged in meandering or looped fashion permit an efficient heat output to the coolant.

The heating device may comprise a plurality of heating elements that are interconnected along the longitudinal direction of the temperature-controlling channel in a form-fit, force-fit or material-fit manner. If these heating elements are integrated as one unit into the temperature regulating system, control or regulation thereof can still be accomplished with little effort. However, it may also be advantageous when individual heating elements can be driven differently from other heating elements so as to produce e.g. temperature profiles along the temperature-controlling channel connected to the heating element or to deactivate individual heating elements if these do e.g. not function properly. To prevent overheating of the heating element or of other components of the temperature regulating system or of the fuel cell, the heating device can convert electrical energy via at least one heating element e.g. in the form of a PTC resistor, the electrical resistance of which rises with its temperature because the PCT resistor automatically limits the maximum heat output. When there is an overheating protection for example in the form of at least one PTC element, the heating elements can e.g. also be configured as heating wires or thick-film heating elements. As a rule, however, an overheating protection must then be provided.

To improve the thermal conductivity between the heating device and the temperature-controlling channel, the areas thereof that are oriented towards each other and at least connected to each other during operation may be designed such that they are complementary to each other.

To improve thermal coupling between the two components heating device and temperature-controlling channel, it is advantageous to enlarge the surface of the interconnected sides. For this purpose the sides may be designed with geometric structures increasing the surface thereof or may be provided with elements that have a surface formed in this way.

To further optimize heat conduction from the heating device to the temperature-controlling channel a heat conducting medium, such as a thermal paste, may be applied to at least one of the facing surfaces.

Likewise, the boundary surfaces of the cooling element and the surfaces of the temperature-controlling channel oriented towards said boundary surfaces of the cooling element can be shaped like the facing surfaces of the heating device and the temperature-controlling channel. The cooling element can form a temperature-controlling stack with the temperature-controlling channel and the heating device. In particular, the cooling element and the temperature-controlling channel can enclose the heating element.

The components of the temperature-controlling layer may also be arranged in a different way and interconnected in a form-fit, force-fit or material-fit heat-conducting way. For instance, the components may be held together by a holding frame. The holding frame may here comprise sealing and/or contact elements for connection of the components to energy, control and/or media circuits.

Also, the heating element can be enclosed at both sides by two cooling elements that can be connected in a heat-conducting way to a temperature-controlling channel at their side facing away from the heating element. With such an arrangement the heat transfer area between the heating element and the cooling elements is increased, whereby a more efficient heat output from the heating element is achieved.

To electrically separate the components from one another and thus to prevent an undesired current flow between the components, an electrical insulating layer may at least be arranged between the heating element and its neighboring components. This insulating layer can also envelop at least the heating elements. In order not to impede the heat exchange by the electrical insulating layer, it may be configured as a heat bridge.

If heat exchange is to be improved, the insulating layers preventing undesired current flow between the components can also be omitted, if corresponding and particularly identical electrical potentials are applied to the components. With this measure the current flow between the components approaches zero.

As an alternative, at least the components surrounding the heating element can also be made from an electrically insulating material of high thermal conductivity.

It may also be advantageous when the components are joined in a different number to form a temperature-controlling stack. If the heat transport medium needs to be heated to a stronger degree, one temperature-controlling channel may be surrounded by two or more heating devices. If the temperature-controlling fluid is to be cooled to a stronger degree, several cooling elements may be connected to the temperature-controlling channel. It is here particularly advantageous when at least one heating device and at least one cooling element are always connected to the temperature-controlling channel, because the temperature-controlling fluid flowing through the temperature-controlling channel and thus also the fuel cell can thereby be heated and cooled.

A temperature-controlling module that may comprise several temperature-controlling stacks which are connectable to each other in a force-fit, form-fit or material-fit way and can be driven individually or jointly can be connected by a holding frame. Said holding frame may also comprise mounting elements and connection devices that may be connectable to mounts, media, supply and/or control circuits. However, the temperature-controlling module itself may also be equipped with the mounting means and the connection devices. Also, the temperature-controlling module may comprise only one temperature-controlling channel that extends in meandering fashion through the temperature-controlling module. Heating devices and cooling elements may be arranged between the parts of the temperature-controlling channel extending in parallel with each other.

If space requirements or other general conditions require that the temperature-controlling module does not extend linearly, the module may also extend in a curved way, whereas the radius of curvature may vary in the course of the temperature-controlling module.

To be able to vary the flow of the temperature-controlling fluid and thus heat transport, at least a regulating unit, with which the heat transport from the temperature-controlling module to the fuel cell is variable, may be provided in the course of the temperature-controlling circuit. Especially, the flow velocity of the temperature-controlling fluid may be varied with the regulating unit. The regulating unit may e.g. be designed as a fluid pump or as a regulating valve. The regulating unit can be arranged at different locations inside the temperature-controlling circuit, e.g. in one of the heat transport lines, in the fuel cell or in the temperature regulating system.

The velocity and the temperature of the temperature-controlling fluid can be varied predominantly independently of each other or linked with each other by the regulating unit and the heating device, which permits a wide range of temperature variations of the fuel cell within a predetermined period of time.

To be able to affect the amount of the heat that can be discharged via the cooling element, a conducting unit for coolant may be provided in the flow direction of the coolant in front of the temperature-controlling module. With this conducting unit the flow vector and particularly the flow direction of the coolant can be influenced. The conducting unit can be spaced apart from the temperature-controlling module, it can be in contact with the module, or it can also be integrated into the module or the holding frame thereof. The conducting unit comprises guiding means that can reduce the size of the cross-section thereof, through which the coolant can flow. Said guiding means can be configured as movable bars or as flaps that are rotatable about an axis, which can also extend in a direction transverse to the flow direction, and can change the through-flow cross-section in dependence upon their position or location.

To control the temperature of for instance a plurality of heat generators jointly, but differently by means of the temperature regulating system, the guiding means can be set within defined through-flow areas differently than in other areas. As a result, different heat amounts can be discharged in different areas of the temperature-controlling module. The conducting unit can be oriented substantially in a direction perpendicular to the flow direction of the coolant and extend in straight but also curved fashion.

To be able to increase the flow velocity of the coolant, the conducting unit may be connected to a conveying device for coolant, e.g. a fan. The conveying device may be arranged in the flow or conveying direction of the coolant in front of or behind the conducting unit. A supply of the coolant to the temperature-controlling module can also be ensured in cases where the coolant does not flow at a sufficiently high velocity without support. This may e.g. be the case if the temperature regulating system is arranged as an air-cooled radiator in an automotive vehicle and the automotive vehicle is at a standstill or only moves at a low speed.

In order to integrate the temperature-controlling module into the fuel cell or into the devices connected to it, it may be advantageous to at least arrange the cooling element in a process air guide path of the vehicle or the fuel cell. The process air guide path can e.g. guide ambient air as process air to the fuel cell past the cooling element or through the cooling element.

The process air guide path can also comprise means for compressing and/or changing the moisture content of the ambient air.

It may here be expedient when the cooling element is arranged between these devices and the fuel cell because the cooling element is then during operation at least partly in contact with the process air with its defined moisture content.

When the whole process air is passed through the conducting unit and/or the cooling element, attention must be paid upon change in the flow vector that an amount of process air needed by the fuel cell can always flow through the conducting unit. Particularly the flow cross-section of the conducing unit should not be reduced too much in its size e.g. by the guiding means.

An energy storage device can store kinetic energy of an automotive vehicle, which in a braking operation is converted by an energy converter, e.g. in the form of a generator, into electrical energy. The temperature-controlling module or the components thereof, the regulating unit, the conducting unit, or the conveying device can be supplied with energy via said energy storage device.

Generated braking energy can be passed in the form of electrical energy into the energy storage device and stored therein. If enough energy is contained in the energy storage device, the temperature regulating system can inter alia be operated with this braking energy. If the energy storage device does not contain any braking energy, the temperature regulating system can also be fed from other sources of electrical energy and particularly with electrical energy generated in the fuel cell. To this the fuel cell can e.g. pass electrical energy into the energy storage device from which the temperature regulating system is fed.

If electrical braking energy arises that, however, cannot or should not be stored, for instance for the reason that the energy storage device is full, the whole electrical braking energy arising can be supplied to the temperature regulating system and used for operation or can be discharged in converted form as heat energy.

The settings at least of the components indicated in the previous paragraph can be regulated by a monitoring or controlling unit in response to the temperature of the fuel cell or other parameters, such as the setting of an air conditioning system connected to the temperature regulating system, an energy storage device monitoring unit or other functional units of the automotive vehicle communicating with the temperature regulating system. To this the monitoring unit is at least connected to at least one temperature sensor, to the heating element, to a conducting unit or to a regulating unit in a measuring, controlling and/or power-regulating manner. The temperature sensor can measure the temperature of the fuel cell and may be arranged in the fuel cell or may be thermoconductively connected to the temperature-controlling channel.

The monitoring unit may be integrated into a control unit, which also regulates or controls other sequences in the automotive vehicle, it may be designed in the temperature regulating system or also separately or as a part of the fuel cell and also connected in a data transmitting fashion to other control units of the automotive vehicle.

If the temperature of the fuel cell is outside the set temperature range, heat can be supplied to or discharged from the fuel cell with the help of the temperature regulating system.

If the temperature of the fuel cell is below the set temperature range for instance after start of the automotive vehicle, the heating device can be supplied with electrical energy. The heating element converts the electrical energy into heat energy and outputs the same to the temperature-controlling channel. The heat can be transported via the temperature-controlling channel to the fuel cell. For instance the fuel cell can thereby be preheated before its start.

If a temperature-controlling fluid is used for heat transportation, said fluid can be conveyed by the regulating unit through the temperature-controlling circuit.

To be able to ensure an energy exploitation that is as efficient as possible for heating the fuel cell and to prevent the heat from flowing off via the cooling element, it is advantageous when the coolant is prevented from absorbing heat and not to conduct the coolant through the conducting means to the cooling element.

When the operating temperature of the fuel cell has reached the set temperature range, the heat transport to the fuel cell can be interrupted and the supply of the heating device with electrical power can be terminated. The regulating unit will no longer pump the temperature-controlling fluid through the temperature-controlling circuit or reduce the flow diameter thereof until the temperature-controlling circuit is interrupted.

For instance, to be able to distribute the heat inside the fuel cell in a better way, the temperature regulating system may be decoupled from the temperature-controlling circuit and the temperature-controlling circuit may be closed via a connectable secondary line. This temperature-controlling circuit part may comprise the regulating unit that makes the temperature-controlling fluid flow. For instance, the heat can here be transported to a temperature sensor connected in a heat-conducting way to the temperature-controlling circuit part outside the fuel cell.

If the temperature of the fuel cell is above the set temperature range, excessive heat of the fuel cell can flow off via the temperature-controlling channel to the temperature regulating system and there be discharged to the coolant flowing past or through the cooling element. For this purpose the regulating unit conveys the temperature-controlling fluid through the temperature-controlling circuit and the conducting means conducts the coolant at least in part to the temperature-controlling module. If the coolant flows with a slower velocity than the predetermined minimum velocity or if its present flow velocity is not enough, the velocity can be raised by the conveying device.

The coolant heated after heat absorption can be used not only for transporting the heat off to the environment, but also for passing the heat on to other heat consumers of the automotive vehicle. For instance, the coolant can discharge the heat to the air flowing by. This air can be passed directly into the interior of the vehicle and the passenger compartment of the vehicle can thereby be heated. If the coolant consists of air, it can directly be passed into the compartment.

Other fluids, such as window cleaning liquid, can also be heated, e.g. to prevent the liquid from freezing. To this the liquid can be passed through the temperature regulating system. As an alternative, the waste heat of the temperature regulating system can e.g. be fed to the window cleaning liquid container. In cases where further heat generators or heat consumers, e.g. a combustion engine, are to be temperature-controlled, the engine may be connected in a heat-conducting way to the temperature regulating system. In particular, a heat transport medium of the heat consumer or the heat generator can also be temperature-controlled with the temperature regulating system.

Braking energy in the form of electrical energy, which can or should not be stored and which is not needed by an energy consumer, can be discharged via the heating device and the cooling element to the coolant. To this the kinetic energy can be supplied via the heating device to the cooling element, which conducts the kinetic energy to the coolant. For this purpose it may be advantageous when the coolant is fed to the cooling element with at least a minimal flow velocity. The regulating unit does not pass the temperature-controlling fluid to the fuel cell unless the temperature thereof is below the set temperature range. The conducting unit and, if necessary, also the conveying device pass coolant to the temperature-controlling module; the coolant absorbs and discharges the heat. In this state the heating device is working as a so-called brake resistor and can be designed as such a resistor.

The kinetic energy can be discharged via the heating device and the cooling element at least partly past the fuel cell to the environment of the cooling element if the temperature of the fuel cell is below the second set temperature.

If there is no braking energy, the heating element can also be supplied from other sources of energy, particularly the energy storage device, which may be designed in the form of a chargeable battery, or from the fuel cell, which can also generate electrical energy. Also a source of energy located outside the vehicle, e.g. a power supply unit connected to the regular power network, can be used particularly at standstill of the vehicle for the supply of the heating element or the other components of the temperature regulating system.

The described settings can also be differently combined or the individual settings can be set stepwise or continuously between their maximum settings that can e.g. be represented as heat transportation through temperature-controlling channel as “maximum” or “off”.

The invention shall now be explained by way of example with reference to embodiments taken in conjunction with the drawings. The different features of the embodiments can here be combined independently of each other, as has already been explained in the case of the individual advantageous developments.

### BRIEF DESCRIPTION OF THE DRAWINGS

FIG. 1 a schematic illustration of a first embodiment of three components of the invention;

FIG. 2 a schematic illustration of a further embodiment of the invention, which differs from the embodiment shown in FIG. 1 in that the three components are joined;

FIG. 3 a schematic illustration of a third embodiment of the invention, which differs from the previous embodiments by a modified arrangement of the components;

FIG. 4 a schematic illustration of a fourth embodiment of the invention;

FIG. 5 a schematic illustration of a fifth embodiment of the invention;

FIG. 6 a schematic illustration of a sixth embodiment of the invention, which is distinguished by an additional fuel cell;

FIG. 7 a schematic illustration of a seventh embodiment of the invention, which differs from the previous embodiments by an additional heat-absorbing media guide unit;

FIG. 8 a schematic illustration of an eighth embodiment of the invention, in which the heat-absorbing media guide unit is impervious to heat-absorbing media;

FIG. 9 a schematic illustration of a ninth embodiment of the invention, which differs from the previous embodiments by an additional control unit; and

FIG. 10 a schematic illustration of operative-state examples of the invention.

### DETAILED DESCRIPTION OF THE PREFERRED EMBODIMENTS

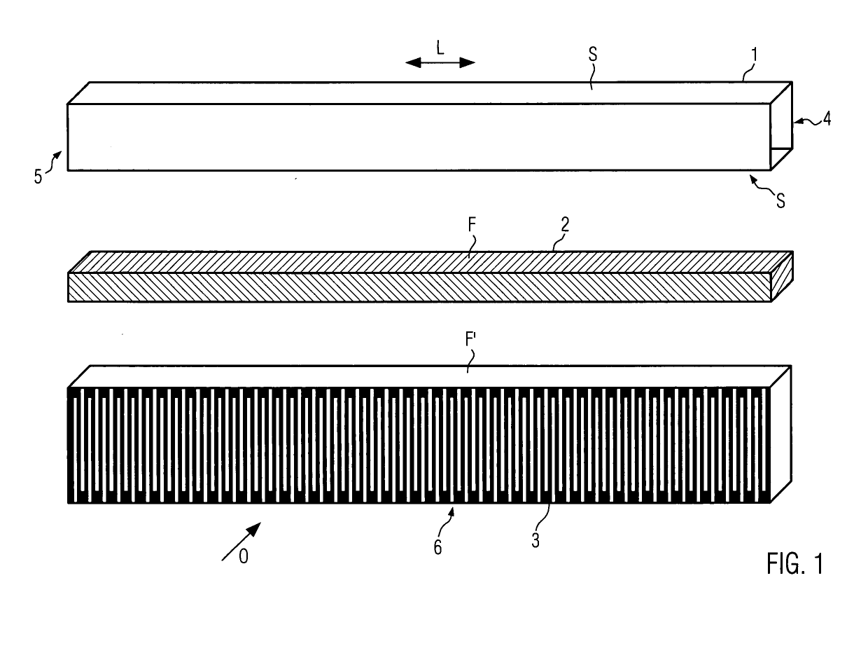

First of all, construction and function of an inventive temperature regulating system for fuel cells shall be described with reference to the embodiment of FIG. 1. Three components of the temperature regulating system are here schematically shown: a temperature-controlling channel 1, an electric heating device 2, and a cooling element 3 through which a gas, for instance air, can flow.

All of the three components have identical rectangular base areas and a cuboid structure. A continuous opening through which a temperature-controlling fluid can flow terminates at the ends 4, 5 of the temperature controlling channel 1 that are oriented in longitudinal direction L. The temperature-controlling channel 1, which has a rectangular cross-section in this instance, may e.g. also be round, oval or formed in any desired cylindrical way or, instead of the even side faces S, it may have uneven and particularly surface-enlarging side faces S. Also, the temperature-controlling channel 1 may be designed on the inside and also on the outside for example with rib-shaped elements. If e.g. the installation conditions or other function or design conditions require a shape other than the straight one along the longitudinal direction L that is shown, the temperature-controlling channel 1 may also extend in curved fashion, with the radius of curvature possibly changing in the course of the temperature-controlling channel 1.

The electric heating device 2 is here e.g. shown as a heating element shaped in the form of a PTC resistor having an electrical resistance increasing with an increasing temperature. The heating element 2 is electroconductively connectable to a source of energy via two connection lines, which are not shown here. Other electric heating elements, such as heating wires or thick-film heating elements, are also possible. The heating device 2 may also consist of a plurality of heating elements and may be stacked along the longitudinal direction L and may be drivable individually, in groups, or jointly. These heating elements may e.g. be interconnected in a form-fit, force-fit or material-fit way or may be accommodated inside a housing or may be cast jointly.

The size of the surface F of the heating device 2, which points towards the temperature-controlling channel 1, influences the efficiency with which the heat generated in the heating element 2 is output to the temperature-controlling channel 1. In this case, too, the surface F may deviate from the even shape and may be shaped in a similar way as the side face S of the temperature-controlling channel 1 that is pointing towards the surface F. Both faces S, F may be shaped such that they have structures that enlarge the surface of the faces S, F or are provided with similarly shaped structural elements. The two faces S, F, which are opposite each other, can be shaped such that they are complementary to each other. A medium that improves the thermal diffusivity, for instance a thermal paste, which for example displaces thermally insulating air between the faces S, F, can also be applied on at least one of the two faces before the temperature-controlling channel 1 and the heating element 2 are brought into contact.

To be able to use also other sources of heat for heating the temperature-controlling fluid, the heating device 2 may also comprise areas through which e.g. gases or liquids heated in the other thermal sources can flow.

To cool the temperature-controlling fluid, media that are colder than the temperature-controlling fluid in the temperature-controlling channel 1 may also flow through the heating element 2. Also, the heating device itself may e.g. be configured in the form of a Peltier element and generate coldness electrically or in another way, e.g. chemically or with the help of compressed media.

If a separate component is needed for cooling the temperature-controlling fluid, said component may be configured in the form of the cooling element 3. The cooling element 3 is here shown with a continuous opening 6 extending in a direction O that is perpendicular to the longitudinal direction L. Heat distribution elements, e.g. in the form of grids or ribs, which are connected in a heat-conducting way to the cooling element and through which a coolant can flow, may be accommodated in the opening 6. In particular, the heat distributing elements, as are here shown, may be meander-shaped and configured as so-called corrugated ribs in the form of sheets. If required by spatial, functional or other general conditions, the continuous opening 6 may also extend in another direction, which may particularly run parallel to the longitudinal direction L.

The face F′ of the cooling element 3 pointing towards the heating device 2 may be shaped like the faces F, S of the heating device 2 and of the temperature-controlling channel 1, respectively.

The illustrated components 1, 2 and 3 are made of a material, particularly of a metal such as aluminum, with a high thermal conductivity that can be insensitive to corrosive external influences and/or may be provided with a protective layer, for instance for corrosion prevention.

Connection elements for connecting the components temperature-controlling channel 1, heating element 2 and heat output element 3 to temperature-controlling circuit, power supply units, coolant feed means or control devices may be directly provided on the components.

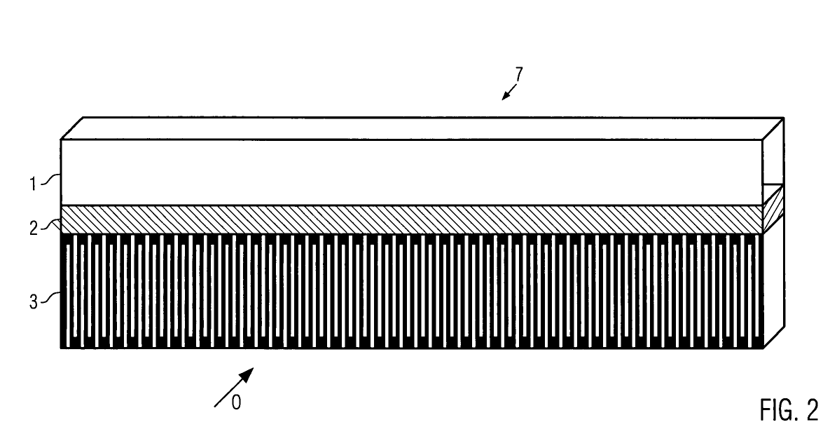

FIG. 2 shows a further embodiment, in which identical reference numerals are used for elements that are identical in function and structure with the elements of the embodiment of FIG. 1. For the sake of brevity only the differences with respect to the embodiment of FIG. 1 shall be discussed.

The three components temperature-controlling channel 1, heating device 2 and cooling element 3 are here arranged on top of each other in a direction perpendicular to direction O and are joined to form a temperature-controlling stack 7. The components may be connected to each other e.g. in a material-fit, form-fit or also force-fit way, clamped in a holding frame, screwed to one another or also connected to one another in a different way. The holding frame can provide the above-described connecting and/or sealing elements for connection.

The arrangement of the components can differ from the illustrated sequence, in which the heating element 2 is enclosed at two sides by the temperature-controlling channel 1 and the heat output or cooling element 3.

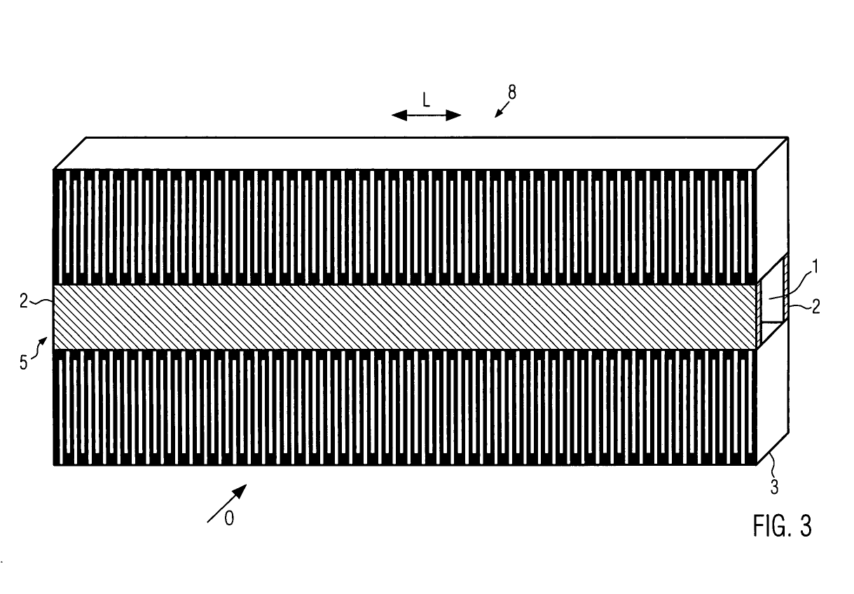

This is shown in FIG. 3. In this third embodiment identical reference numerals are used for elements that are identical in function and structure with the elements of the embodiments of FIG. 1 or 2. For the sake of brevity only the differences with respect to the embodiments of FIGS. 1 and 2 shall be discussed.

In the temperature-controlling stack 8, as is shown here, two heating devices 2 are shown that are connected and arranged in a plane with a temperature-controlling channel 1, with the two heating devices 2 encompassing the temperature-controlling channel 1 in direction O. One cooling element 3 bridges the two heating devices 2 and the temperature-controlling channel 1 at each different side.

The components 1, 2, 3 can be separated from one another through an electrical insulator, whereby undesired current flow between the components is suppressed. The insulator may be arranged between the components 1, 2, 3 as an insulating layer or foil or also cover the components 1, 2, 3, particularly the heating element 2, on all sides without impeding fluid flows or connections.

If undesired current flow is to be prevented without insulating layers between the components 1, 2, 3, the components 1, 2, 3 may comprise connections through which corresponding and particularly identical electrical potentials can be applied to the components 1, 2, 3. Said connections may e.g. be shaped as plug-in contacts or also as contact surfaces between the components 1, 2, 3.

As an alternative, at least the components 1, 2, 3 adjoining the heating element 2 can be made from an electrically insulating material.

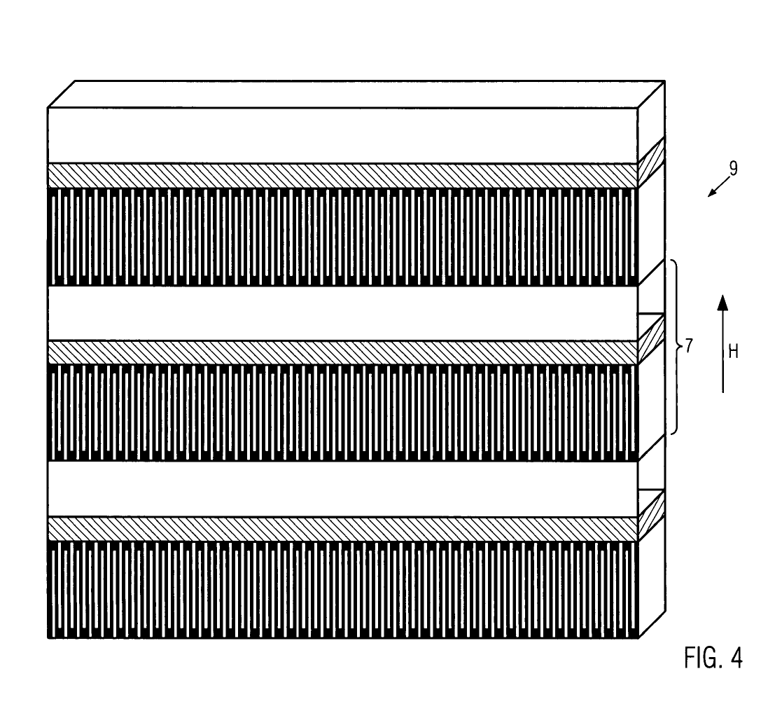

FIG. 4 shows a fourth embodiment, with identical reference numerals being used for elements that are identical in function and structure with the elements of the embodiments of the former figures. For the sake of brevity only the differences with respect to the embodiments of the already described figures shall be discussed.

In FIG. 4, the shown temperature-controlling unit 9 comprises three temperature-controlling stacks 7 that are stacked one on top of the other in a direction H oriented perpendicular to direction O, the stacks 7 being retrofitable by additional temperature-controlling stacks 7, 8 or components 1, 2 or 3. The additional components 1, 2 or 3 or temperature-controlling stacks 7, 8 can be added to or mounted on the temperature-controlling unit 9 in direction H or can also be brought into thermal contact with the temperature-controlling unit 9 in a direction perpendicular to direction H in front of or behind the temperature-controlling unit 9. The temperature-controlling stacks 7, 8 and components 1, 2 or 3, respectively, can be interconnected in a form-fit, material-fit or force-fit way and e.g. be surrounded by a frame that can provide connections for connection to electric circuits, heat transport media supplies or heat-absorbing media supply devices.

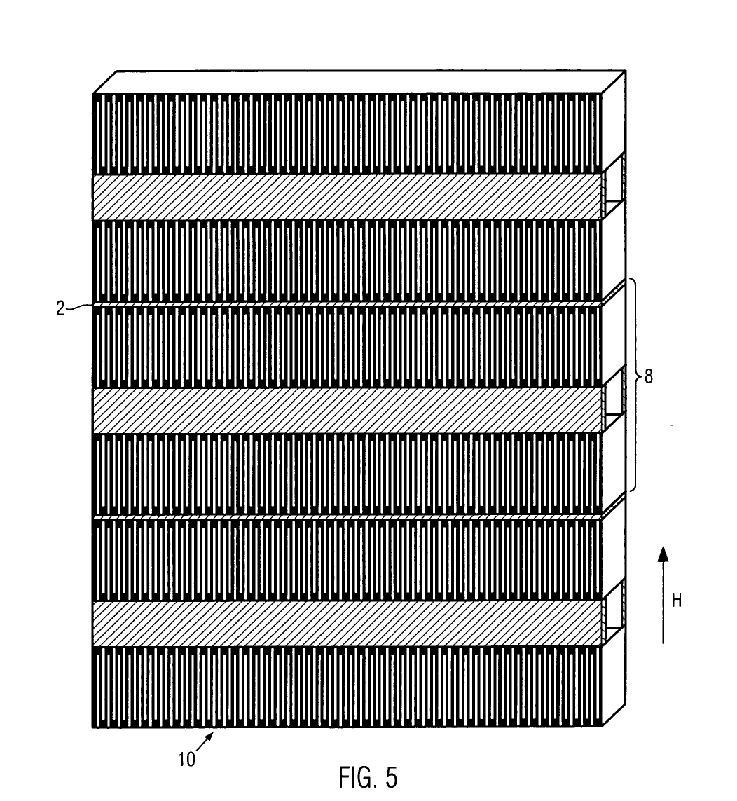

A fifth embodiment is shown in FIG. 5, where identical reference numerals are also used in this instance for elements that are identical in function and structure with the elements of the embodiments of the preceding figures. For the sake of brevity only the differences with respect to the embodiments of the already described figures shall be discussed.

In FIG. 5 three temperature-controlling stacks 8 are stacked one on top of the other along direction H and are each shown separated from one another by an additional heating device 2. To enhance the temperature-controlling performance of the temperature regulating system, the temperature-controlling unit 10 as shown here may be added further temperature-controlling stacks 7, 8 or components 1, 2 or 3. If the heating power is to be increased, the temperature-controlling unit 10 may be added further heating devices 2. To increase the cooling efficiency, further cooling elements 3 may be provided. Also, the geometric conditions may deviate from the ones as are shown here. For instance, the dimension of the cooling elements 3 can particularly be varied in direction H, whereby the cooling capacity can be influenced.

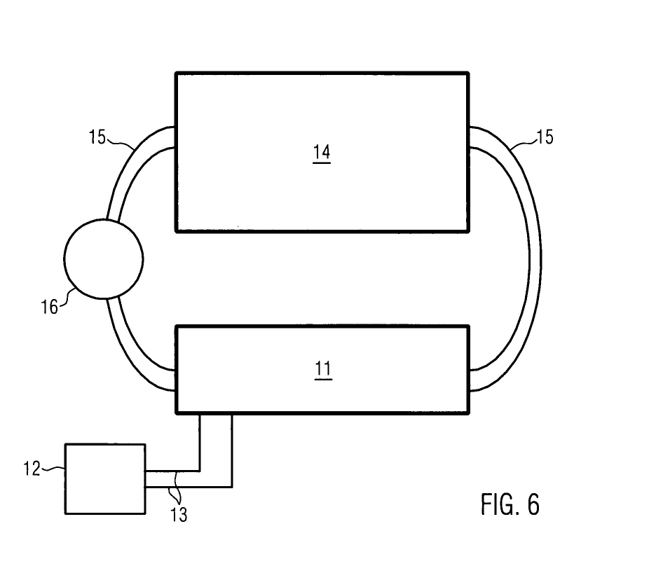

FIG. 6 shows a sixth embodiment, where identical reference numerals are used for elements that are identical in function and structure with the elements of the embodiments of the preceding figures. For the sake of brevity only the differences with respect to the embodiments of the already described figures shall be discussed.

The temperature-controlling unit 9, 10 is here shown integrated into the temperature-controlling module 11. Furthermore, the temperature-controlling module 11 optionally comprises a holding frame which can also comprise auxiliary mounting elements and connecting options for media circuits or electric circuits. The auxiliary mounting elements can e.g. be designed for attachment of the temperature-controlling module to mounting elements in the engine compartment of an automotive vehicle or for mounting further devices.

An electric supply unit 12 which may comprise an energy storage device and may be connected to an energy converter is connected via lines 13 at least to the heating devices 2 of the temperature-controlling module 11 and can thus electrically power the same.

Here the temperature-controlling circuit comprises the temperature-controlling module 11, a fuel cell 14 and two heat transport lines 15 that connect the temperature-controlling module 11 and the fuel cell 14 in a temperature-controlling media conducting way.

One of the heat transport lines 15 is interrupted by a regulating unit 16, which is here configured as a temperature-controlling medium pump and can vary a flow velocity and/or flow direction of the temperature-controlling medium, for instance from zero up to a maximum velocity.

The temperature-controlling channel 1 can here also be guided as a single temperature-controlling channel 1 with only two open ends, for instance, in meandering fashion through the temperature-controlling module 11.

Likewise, the temperature-controlling fluid can flow through a fluid collection unit, which is connected to the temperature-controlling channels 1 in a fluid-conducting way.

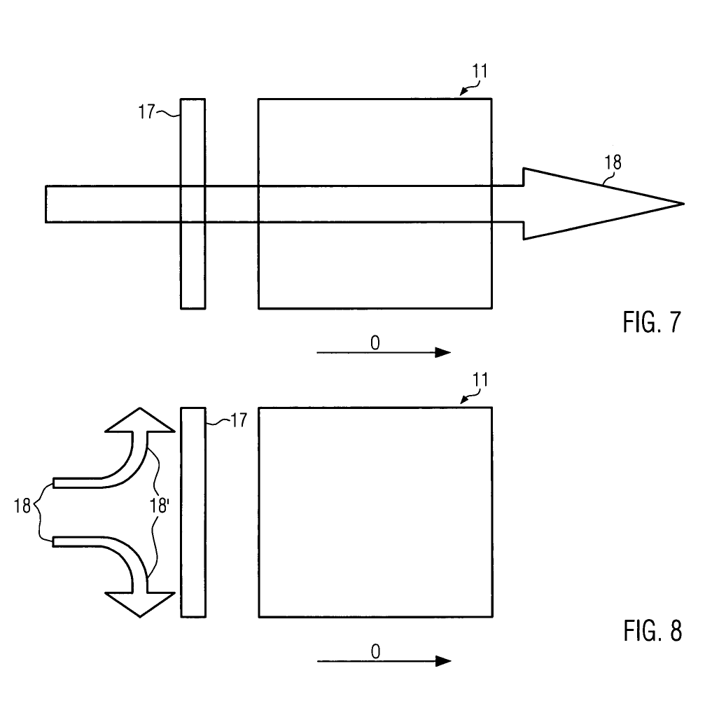

A seventh embodiment is shown in FIG. 7, identical reference numerals being here also used for elements that are identical in function and structure with the elements of the embodiment of the preceding figures. For the sake of brevity only the differences with respect to the embodiments of the already described figures shall be discussed.

A gaseous coolant is here flowing through the temperature-controlling module 11. The coolant may e.g. be formed of a gas mixture such as air and is passed substantially along the flow direction 18 running in direction O through the opening 6 of the cooling element 3. The coolant can also be a process gas of the fuel cell 14, with the gas mixture, before reaching the fuel cell 14 and optionally also the temperature-controlling module 11, being compressed by devices arranged in direction 18 in front of the temperature-controlling module 11, and/or the moisture content thereof being varied.

In a direction opposite direction O, a conducting unit 17 for coolant is shown, which is oriented substantially in a direction perpendicular to said direction O and through which the heat-absorbing medium can also flow. With the conducting unit 17 the flow vector of the coolant can be varied. The conducting unit 17, which is here shown spaced apart from the temperature-controlling module 11, can also contact the module 11 or may be an integral part of the temperature-controlling module 11.

FIG. 8 shows the embodiment of FIG. 7, with the conducting unit 17 being here shown to be set such that it is impervious to the coolant. The direction of flow 18 of the coolant is here changed by the conducting unit 17 into the direction 18′ oriented perpendicular to direction 18. The conducting unit 17 can vary the flow of the coolant stepwise or continuously. To this the conducting unit 17 can for example have bars that are movable along a direction substantially perpendicular to the direction O for reducing the size of or for closing flow areas of the conducting unit 17. The flow of the coolant can e.g. also be varied with flaps, each being rotatable about an axis positioned perpendicular to the direction O and forming a substantially closed area perpendicular to direction O at a specific position. When the coolant is also used as a process gas of the fuel cell 14, it is to be ensured that adequate amounts of the process gas reach the fuel cell 14. To this, in the closed state of the conducting unit 17, the process gas can be guided around the temperature-controlling module 11 towards the fuel cell 14. The conducting unit 14 can also be configured or set such that it always lets pass the necessary amount of process gas.

Likewise, the conducting unit 17 can be connected to a conveying unit for coolant that can vary the flow velocity of the coolant. The conveying unit can e.g. be configured as a fan.

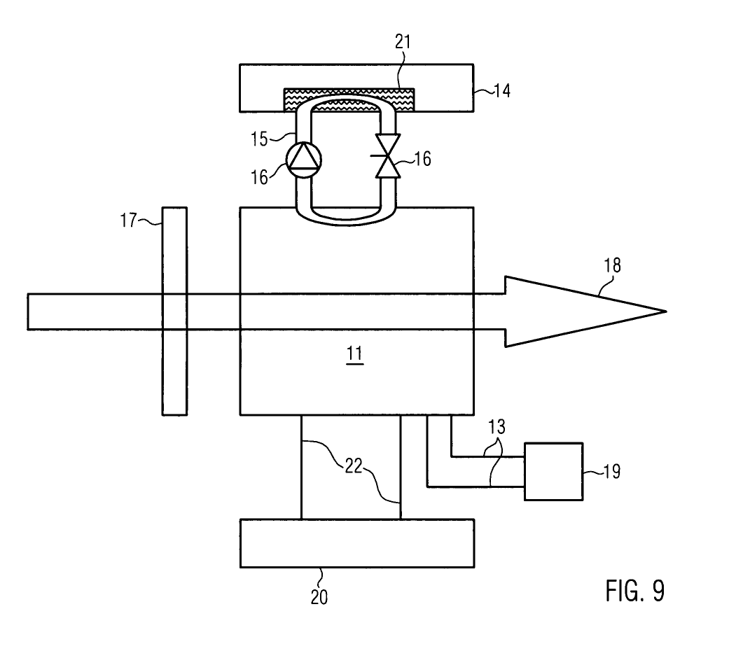

FIG. 9 shows an eighth embodiment, identical reference numerals being here also used for elements that are identical in function and structure with the elements of the embodiments of the preceding figures. For the sake of brevity only the differences with respect to the embodiments of the already described figures shall be discussed.

In FIG. 9, apart from the temperature-controlling unit 11 and the conducting unit 17, the fuel cell 14 and an energy converter in the form of a current generator 19 and a control unit 20 are here shown. The fuel cell 14 is here also shown with two heat transport media lines 15 connected to the temperature-controlling unit 11 to form a temperature-controlling circuit, which may also comprise more than two heat transport media lines 15. The temperature-controlling fluid, however, is here not flowing through the areas of the fuel cell 14 to be temperature-controlled, as has so far been the case, but through a heat exchanger 21. The heat exchanger 21 may be integrated into the fuel cell 14, arranged as a separate component or disposed in the temperature-controlling module 11. The heat exchanger 21 may have a heat conducting medium flowing therethrough, with the medium transporting heat to be transported away from or towards the fuel cell 14.

One of the heat transport lines 15 is here also flowably interrupted by the regulating unit 16, which is configured as a pump for temperature-controlling fluids. Along the second heat transport line 15 a further regulating unit 16 is provided in the form of a regulating valve with which the flow cross-section of the heat transport line 15 can be varied in the area of the valve. The temperature-controlling module 11 is electroconductively connected via electrical lines 13 to the generator 19.

Kinetic energy can be converted into electrical energy with the generator 19. The generator 19 can also fill an energy storage device of the supply unit 12, which unit passes excessive energy, for instance when the storage device is filled, to the temperature-controlling module 11 and the heating device, respectively, which is here acting as a brake resistor. If the energy storage device is empty and if no converted braking energy is available, the temperature-controlling module 11 may also be connected to the fuel cell 14 in an energy-conducting way. The energy storage device may also be connected to the fuel cell in order to be filled with energy.

The control unit 20 is connected via control lines 22 at least to a temperature sensor which measures the temperature of the temperature-controlling fluid and/or the fuel cell 14, to the regulating unit 16, to the conducting unit 17 and/or to the heating device 2. The control unit 20 can also be connected in a power-regulating way between the temperature-controlling system and energy sources supplying the system with electric power.

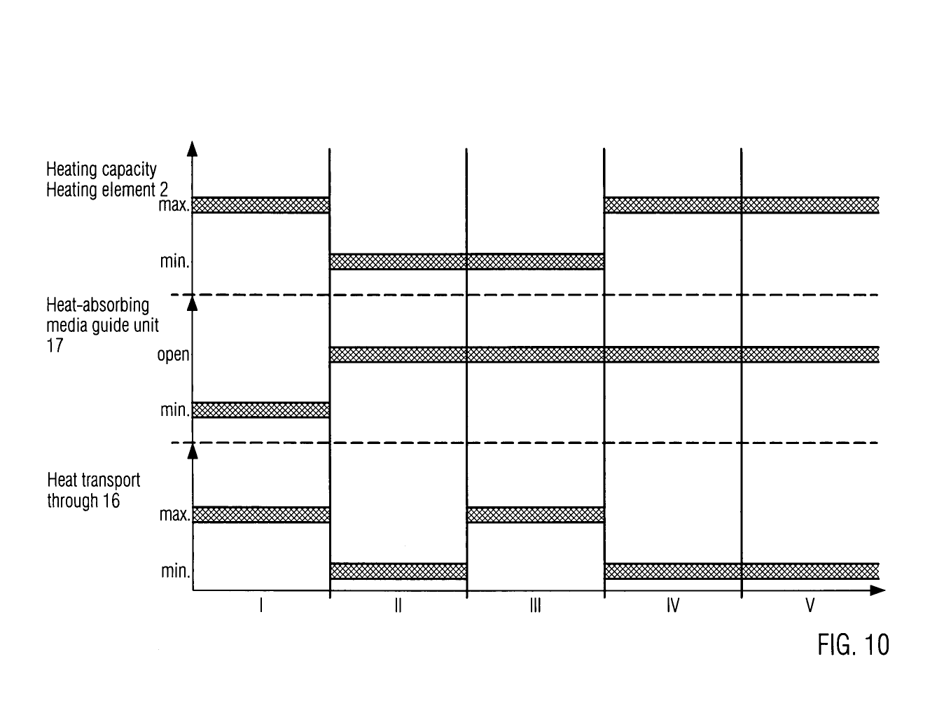

FIG. 10 shows a ninth embodiment, with identical reference numerals being used for elements that are identical in function and structure with the embodiments of the preceding figures. For the sake of brevity only the differences with respect to the embodiments of the already described figures shall be discussed.

Here operative states of the functional units heating element 2, regulating unit 16 and conducting unit 17 are shown by way of example in dependence upon operative states of the fuel cell 14 and in dependence upon other requirements, respectively.

In Example I the temperature T of the fuel cell 14 is below a predetermined first set temperature Tu. To heat the fuel cell 14 as fast as possible to an operating temperature T above the limit temperature Tu, the heating device 2 converts an intended and optionally maximally possible amount of electrical energy per time unit into heat and outputs the heat to the temperature-controlling fluid. The temperature-controlling fluid heated in this way is conveyed to the fuel cell 14 to which it delivers the heat at least in part. To this the regulating unit 16 is set to maximum heat transport. To at least minimize heat losses to the environment of the temperature-controlling module 11, the conducting unit 17 is set to be impervious to the coolant, so that e.g. no cooling air can flow through the temperature-controlling module 11. With the settings described in this example, the fuel cell 14, for instance, can be supported in a start phase during its self-heating. If the coolant is also used as a process gas of the fuel cell 14, the conducting unit is open at least in part, so that enough process gas can flow towards the fuel cell 14.

In Example II the temperature T of the fuel cell 14 is within a set temperature range that is distinguished by the first set temperature Tu and a second higher set temperature To. The heating device 2 is not supplied with energy; the conducting unit 17 lets the coolant or process gas flow to the fuel cell 14 and the regulating unit 16 does not convey any temperature-controlling fluid or closes at least one heat transport line 15.

If, however, the heat transport medium is e.g. used for distributing the heat also inside the fuel cell 14, the temperature of the fuel cell 14 is determined with reference to the temperature of the heat transport medium, if necessary, also outside the fuel cell 14, or if the heat transport medium is not to be prevented or cannot be prevented from flowing for other reasons, the flow velocity thereof may also be greater than zero.

If, as shown in Example III, the temperature T of the fuel cell 14 is higher than the second set temperature To, the heating element 2 is not supplied with energy, the conducting unit 17 lets the maximally possible amount of coolant flow to the temperature-controlling module 11 and the flow velocity of the temperature-controlling fluid is maximum.

In Example IV the operating temperature T of the fuel cell 14 is within the set range. The energy storage device of the automotive vehicle, however, can or shall not absorb the kinetic energy converted in a braking process into electrical energy. Therefore, the electrical energy is converted via the heating device 2 into heat energy and is output to the coolant flowing through the temperature-controlling module 11. To this the conducting unit 17 is completely opened.

In order not to change the optimum temperature T of the fuel cell 14 in an unnecessary way, the temperature-controlling fluid is not passed through the regulating unit 16 from the temperature-controlling module 11 to the fuel cell 14.

The temperature-controlling fluid can now also circulate via a connectable secondary line of the temperature-controlling circuit past the temperature-controlling module 11.

If the operating temperature T of the fuel cell 14 is within the set temperature range and if according to Example V a heat consumer or e.g. the passenger compartment of the automotive vehicle is to be supplied with heat, energy can be supplied to the heating device 2, the energy being discharged in the form of heat to air flowing by. The heat can also be delivered to another coolant, which is also conducted via separate lines.

The flow of the temperature-controlling fluid from the temperature-controlling module 11 to the fuel cell 14 is stopped. The conducting unit 17 conducts the coolant to the temperature-controlling module 11. Subsequently, the heated coolant is passed on to the heat consumer or is discharged.

The operative state of the temperature regulating system can differ from the examples shown in FIG. 10. In particular, the states of the individual functional units heating element 2, regulating unit 16 and/or heat-absorbing media guide unit 17 may also lie between the states shown. For instance, the heating element 2 can also be supplied with less than the maximum power, the temperature-controlling fluid may be conveyed at a slower pace than with the maximum velocity, and the stream of the coolant through the temperature-controlling module 11 can only be deflected in part by the conducting unit 17. These different operative states can be regulated by the control unit 20 in dependence upon the temperature T of the fuel cell 14 or by other general conditions, respectively.

While the present invention has been described with respect to several embodiments, it will be understood that various modifications may be made without departing from the spirit or scope of the invention.

What is claimed is:

1. A temperature regulating system for fuel cells (14), comprising at least one electric heating device (2) and at least one cooling element (3), the heating device (2) and the cooling element (3) being connected via a heat bridge to at least one temperature-controlling channel (1) passing through the temperature regulating system, the temperature-controlling channel (1) being connectable in fluid-conducting fashion to a heat transport line (15) which is formed at least between the temperature regulating system and the fuel cell (14) by a temperature-controlling circuit conducting a temperature-controlling fluid, wherein the temperature-controlling channel (1), the cooling element (3) and the heating device (2) are joined to form a temperature-controlling stack (7, 8).

2. The temperature regulating system according to claim 1, wherein the temperature-controlling channel (1), the cooling element (3) and the heating device (2) are arranged in stacked fashion one on top of the other along a longitudinal direction (L) of the temperature-controlling channel (1) to form the temperature-controlling stack (7, 8).

3. The temperature regulating system according to claim 1, wherein two heating devices (2) and two cooling elements (3) encompass the temperature-controlling channel (1) to form the temperature-controlling stack (7, 8), and the two heating devices (2) are arranged at different sides of the temperature-controlling stack (7, 8).

4. The temperature regulating system according to claim 1, wherein the temperature-controlling stack (7, 8) comprises at least one further heating device (2) or at least one further cooling element (3).

5. The temperature regulating system according to claim 1, wherein the temperature regulating system comprises a temperature-controlling module (11) with a plurality of temperature-controlling stacks (7, 8) arranged one on top of the other and in a joint direction.

6. The temperature regulating system according to claim 5, wherein the temperature-controlling module (11) comprises a temperature-controlling channel (1) which extends in meandering fashion through the temperature-controlling module (11).

7. The temperature regulating system according to claim 5, wherein the temperature-controlling module (11) is designed to extend in straight or curved fashion.

8. The temperature regulating system according to claim 1, wherein the heating device (2) is configured as a brake resistor.

9. The temperature regulating system according to claim 1, wherein the heat transport line (15) comprises at least one regulating unit (16) which controls the heat flow and with which a flow velocity of a temperature-controlling fluid is controllable.

10. The temperature regulating system according to claim 1, wherein the temperature regulating system comprises a conducting unit (17) for changing a flow vector of a coolant absorbing the thermal energy of the cooling element (3).

11. The temperature regulating system according to claim 1, wherein a control unit (20) is at least controllably connected to at least one temperature sensor sensing an operating temperature (T) of the fuel cell (14), to the heating device (2), to the regulating unit (16) and/or to the conducting unit (17).

12. The temperature regulating system according to claim 1, wherein the temperature regulating system is additionally connectable in heat-regulating fashion to further heat generators and/or consumers arranged in the automotive vehicle.

13. A method for regulating an operating temperature of a fuel cell, wherein a heat flow is conducted from a heating device (2) via a heat transport line (15) to the fuel cell (14), and the heating device (2) is fed from a source of electrical energy or an energy storage device if the operating temperature is below a first set temperature (Tu), and wherein, when a second set temperature (To) is exceeded, the heat flow is conducted from the fuel cell (14) via the heat transport line (15) to a cooling element (3), wherein the heat flow is passed over at least one temperature regulating system (7, 8).

14. The method according to claim 13, wherein the energy for operating the heating device (2) is taken from the kinetic energy of an automotive vehicle during braking.

15. A fuel cell (14), wherein the fuel cell (14) comprises a temperature regulating system designed as an air-cooled radiator for an automotive vehicle according to claim 1.

16. A fuel cell temperature regulating system as in claim 1, further comprising:
a fuel cell thermally coupled to the temperature-controlling stack,
whereby said fuel cell may be a temperature regulating system designed as an air-cooled radiator for an automotive vehicle.

17. A fuel cell temperature regulating system comprising:
a temperature controlling channel capable of conducting a fluid and having a side face;
an electric heating device having opposing first and second surfaces, the opposing first surface matching the side face of said temperature controlling channel, the opposing first surface contacting the side face;
a cooling element having a face, the face matching the opposing second surface of said electric heating device, the face of said cooling element contacting the opposing second surface of said electric heating device, said temperature controlling channel, said electric heating device, and said cooling element joined to form a temperature controlling stack;
a heat transport line coupled to said temperature controlling channel;
a regulating unit coupled to said heat transport line, whereby fluid flow is regulated; and
a control unit coupled to the temperature controlling stack,
whereby an operating temperature of a fuel cell can be maintained between a first set temperature and a second set temperature for optimum performance.

18. A fuel cell temperature regulating system as in claim 17 further comprising:
a conducting unit, said conducting unit directing gaseous coolant flow through the temperature controlling stack.
